(19) United States
(12) Patent Application Publication
(10) Pub. No.: US 2024/0191028 A1
(43) Pub. Date: Jun. 13, 2024

(54) COMPOSITION FOR MANUFACTURING POLYIMIDE FILM AND POLYIMIDE FILM FOR FLEXIBLE METAL CLAD LAMINATE MANUFACTURED USING THE SAME

(71) Applicant: NEXFLEX CO., LTD., Chungcheongbuk-do (KR)

(72) Inventors: So Jeong KIM, Daejeon (KR); Joo Young KIM, Daejeon (KR); Hyuk Jun KIM, Daejeon (KR)

(73) Assignee: NEXFLEX CO., LTD., Chungcheongbuk-do (KR)

(21) Appl. No.: 17/757,101

(22) PCT Filed: Apr. 13, 2022
(86) PCT No.: PCT/KR2022/005319

§ 371 Date: Oct. 19, 2023

(51) Int. Cl. C08G 73/10; B32B 15/08; C08J 5/18

(52) U.S. Cl. CPC C08G 73/1007; C08J 5/18; B32B 15/08; C08J 2433/00

(57) ABSTRACT

The present disclosure relates to a composition for manufacturing a polyimide film and a polyimide film for a flexible metal clad laminate manufactured using the same. According to an aspect of the present disclosure, there is provided a composition for manufacturing a polyimide film, the composition comprising: an aromatic dianhydride; a diamine; and a curing catalyst, wherein the curing catalyst includes one or more selected from the group consisting of an imidazole-based compound, a quinolone-based compound, and a quinoline-based compound.

### TECHNICAL FIELD

The following description relates to a composition for manufacturing a polyimide film and a polyimide film for a flexible metal clad laminate manufactured using the same.

### BACKGROUND ART

A flexible printed circuit board (FPCB) is a PCB manufactured to be used when a circuit board's flexibility and a thin board are required, and with the recent trend of miniaturization, high speed, and various functions of electronic devices being combined, high-speed transmission, weight reduction, plate thickness reduction, and miniaturization are progressing day by day, and corresponding technology development for FPCB material is required.

Currently, display panel manufacturers are making various attempts to minimize the bezel, and one of them is to minimize the bezel by folding back the FPCB located on the edge portion of a display panel.

However, when such a method is used, the FPCB of the edge portion of the display panel is folded back so that there is a problem in that the bonding portion is detached due to the repulsive force of a circuit material while the bonding area is reduced.

FIG. 1 schematizes a form in which the display bezel is reduced by folding back the FPCB of a display panel edge portion. This shows that as the bonding area of the FPCB is reduced in a state that the FPCB of the display panel edge portion is folded back, there may be a problem in that the bonding portion is detached due to the repulsive force of the circuit material.

For this reason, a flexible metal clad laminate (FMCL) material which not only has high flexural properties, but also has low repulsion properties, so that it can adhere well even to a minimization of the bonding area, is required.

However, since polyimide, which is generally an insulating layer material of a flexible metal clad laminate, has structurally high dimensional stability and strong repulsion properties at the same time, there is a problem in that dimensional stability is also reduced when the repulsion properties are reduced.

Therefore, there is a need for a polyimide film manufacturing technology capable of simultaneously improving high flexural properties, low repulsion properties, and dimensional stability.

The above-mentioned background art is possessed or acquired by the inventor in the process of deriving the disclosure of the present application and cannot necessarily be said to be a known technology disclosed to the general public prior to the present application.

### DISCLOSURE OF THE INVENTION

### Technical Goals

The present disclosure is to solve the above problems, and an aspect of the present disclosure provides a composition for manufacturing a polyimide film, the composition capable of improving all of flexural properties, heat resistance, dimensional stability, and repulsion properties of the polyimide film, and a polyimide film and a flexible metal clad laminate which are manufactured using the same.

However, the problems to be solved by the present disclosure are not limited to those mentioned above, and other problems not mentioned will be clearly understood by those skilled in the art from the following description.

### Technical Solutions

According to an aspect of the present disclosure, there is provided a composition for manufacturing a polyimide film, the composition including: an aromatic dianhydride; a diamine; and a curing catalyst, in which the curing catalyst includes one or more selected from the group consisting of an imidazole-based compound, a quinolone-based compound, and a quinoline-based compound.

In an example embodiment, the aromatic dianhydride may include one or more selected from the group consisting of pyromellitic dianhydride (PMDA), biphenyltetracarboxylic dianhydride (BPDA), bisphenol-A dianhydride (BPADA), and 4,4′-(hexafluoropropylidene)diphthalic anhydride (6FDA).

In an example embodiment, the diamine may include: a first diamine including p-phenylenediamine (p-PDA), m-phenylenediamine (m-PDA), or both thereof; a second diamine including 4,4′-oxydianiline (ODA), 4,4′-methylenedianiline (MDA), or both thereof; and a third diamine including 2-(4-aminophenyl)-5-amino-benzimidazole (PBI).

In an example embodiment, the third diamine may be contained in an amount of 1 mol % to 30 mol % based on the total content of the diamine.

In an example embodiment, the diamine may be contained in an amount of 10 parts by weight to 200 parts by weight based on 100 parts by weight of the aromatic dianhydride.

In an example embodiment, the curing catalyst may be contained in an amount of 5 parts by weight to 40 parts by weight based on 100 parts by weight of the total content of the aromatic dianhydride and the diamine.

In an example embodiment, the imidazole-based compound may include one or more selected from the group consisting of imidazole, benzimidazole, 1-methylimidazole, 1-(trimethylsilyl)-imidazole, 1,2-dimethylimidazole, 1-(3-aminopropyl)-imidazole, 2-alkylimidazole, 2-ethylimidazole, 2-ethyl-4-methylimidazole, 2-phenylimidazole, 2-undecylimidazole, and 3-phenylimidazole.

In an example embodiment, the quinolone-based compound may include one or selected from the group consisting of quinolone, 1,2-dihydro-2,2,4-more trimethylquinolone, 2-chloro-3-(chloromethyl)quinolone, 4-(4-dimethylaminostyryl)quinolone, and 6-(aminomethyl) quinolone.

In an example embodiment, the quinoline-based compound may include one or more selected from the group consisting of quinoline, isoquinoline, and benzoquinoline. In an example embodiment, the composition for manufacturing a polyimide film may have a solid content of 5% by weight to 20% by weight and a viscosity of 10,000 cP to 30,000 cP.

According to another aspect of the present disclosure, there is provided a method for preparing a composition for manufacturing a polyimide film, the method including the steps of: preparing a diamine solution by dissolving a diamine in an organic solvent; and injecting an aromatic dianhydride and a curing catalyst into the diamine solution, in which the curing catalyst includes one or more selected from the group consisting of an imidazole-based compound, a quinolone-based compound, and a quinoline-based compound.

According to another aspect of the present disclosure, there is provided a polyimide film for a flexible metal clad laminate, which is manufactured from a composition for manufacturing a polyimide film, the composition including: an aromatic dianhydride; a diamine; and a curing catalyst, and which has a Young's modulus of 5 GPa or less and a coefficient of thermal expansion (CTE) of 15 ppm/K or less.

In an example embodiment, the polyimide film for the flexible metal clad laminate may have the number of bending of 10,000 times or more in the MIT flexural property test using the JIS C 6471 method in a state in which a coverlay is attached.

In an example embodiment, the polyimide film for the flexible metal clad laminate may have a dimensional change rate of 0.1% or less measured after heat treatment at a temperature of 150° C. for 30 minutes, and the dimensional change rate may be calculated by Equation 1 below.

Dimensional change rate (%)={(average distance between holes after heat treatment−average distance between holes before heat treatment)/average distance between holes before heat treatment}×100. [Equation 1]

In an example embodiment, the polyimide film for the flexible metal clad laminate may have a stiffness of 1.0 N/m to 1.7 N/m.

According to another aspect of the present disclosure, there is provided a flexible metal clad laminate including: a metal foil; and the polyimide film laminated on one or both surfaces of the metal foil.

In an example embodiment, the metal foil may include one or more selected from the group consisting of a rolled copper foil (RA, roo-annealed), an electrodeposited copper foil (ED, electrodeposition), an aluminum foil, and a nickel foil.

### Advantageous Effects

The composition for manufacturing a polyimide film according to the present disclosure has an effect capable of improving flexural properties, heat resistance, dimensional stability, and repulsion properties of the polyimide film.

Further, the polyimide film according to the present disclosure can ensure excellent adhesive properties even when the bonding area is reduced by having high flexural properties, high dimensional stability, and low repulsion properties at the same time.

Furthermore, the flexible metal clad laminate according to the present disclosure has an effect suitable for being applied as a raw material of an FPCB used in order to minimize a bezel.

### BRIEF DESCRIPTION OF DRAWINGS

FIG. 1 schematizes a form in which the display bezel is reduced by folding back the FPCB of a display panel edge portion.

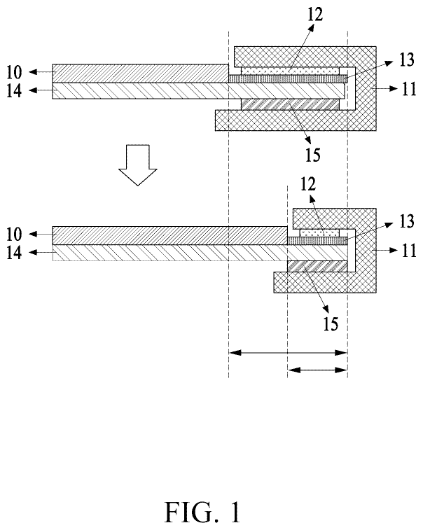

FIG. 2 is a drawing showing a cross-section of a flexible metal clad laminate according to an example embodiment of the present disclosure.

FIG. 3 is for explaining the specific calculation method of the dimensional change rate, and shows the position of each hole in the specimen.

### BEST MODE FOR CARRYING OUT THE INVENTION

Hereinafter, example embodiments will be described in detail with reference to the accompanying drawings. However, since various changes may be made to the example embodiments, the scope of rights of the patent application is not restricted or limited by these example embodiments. It should be understood that all modifications, equivalents, and substitutes for the example embodiments are included in the scope of the rights.

The terms used in the example embodiments are used for the purpose of description only, and should not be construed as an intention to limit the present disclosure. The singular expression includes the plural expression unless the context clearly dictates otherwise. In the present specification, it should be understood that a term such as “comprise”, “have”, or the like is intended to designate that a feature, a number, a step, an operation, a component, a part, or a combination thereof described in the specification exists, but it does not preclude the possibility of existence or addition of one or more other features, numbers, steps, operations, components, parts, or combinations thereof.

Unless defined otherwise, all terms used herein, including technical or scientific terms, have the same meaning as those commonly understood by those skilled in the art to which the example embodiments belong. Terms such as those defined in a commonly used dictionary should be interpreted as having a meaning consistent with the meaning in the context of the related art, and should not be interpreted in an ideal or excessively formal meaning unless explicitly defined in the present application.

Further, in the description with reference to the accompanying drawings, the same components are assigned the same reference numerals regardless of the drawing numerals, and overlapping descriptions thereof will be omitted. In the description of the example embodiments, if it is determined that a detailed description of a related known technology may unnecessarily obscure the gist of the example embodiments, the detailed description thereof will be omitted.

Further, in describing constituent elements of the example embodiments, terms such as first, second, A, B, (a), (b), etc. may be used. These terms are only for distinguishing the constituent elements from other constituent elements, and essences, orders, or sequences of the corresponding constituent elements are not limited by the terms. When it is described that a constituent element is “linked”, “coupled”, or “connected” to another constituent element, the constituent element may be directly linked or connected to the other constituent element, but it should be understood that another constituent element may also be “linked”, “coupled”, or “connected” between the respective constituent elements.

Constituent elements included in any one example embodiment and constituent elements including a common function will be described using the same names in other example embodiments. Unless otherwise stated, descriptions described in any one example embodiment may also be applied to other example embodiments, and detailed descriptions will be omitted in the overlapping range.

An aspect of the present disclosure provides a composition for manufacturing a polyimide film, the composition including: an aromatic dianhydride; a diamine; and a curing catalyst, in which the curing catalyst includes one or more selected from the group consisting of an imidazole-based compound, a quinolone-based compound, and a quinoline-based compound.

The composition for manufacturing a polyimide film according to the present disclosure has an effect capable of improving heat resistance, dimensional stability, flexural properties, and low repulsion properties of the polyimide film by including an aromatic dianhydride, a diamine, and a curing catalyst.

The composition for manufacturing a polyimide film according to the present disclosure includes an aromatic dianhydride.

The aromatic dianhydride has characteristics capable of improving heat resistance and dimensional stability of the polyimide film.

In an example embodiment, the aromatic dianhydride may include one or more selected from the group consisting of pyromellitic dianhydride (PMDA), biphenyltetracarboxylic dianhydride (BPDA), bisphenol-A dianhydride (BPADA), and 4,4′-(hexafluoropropylidene)diphthalic anhydride (6FDA).

In an example embodiment, the aromatic dianhydride may include: a first aromatic dianhydride including pyromellitic dianhydride (PMDA); and a second aromatic dianhydride including biphenyltetracarboxylic dianhydride (BPDA).

In an example embodiment, the aromatic dianhydride may include 10 moles to 500 moles, preferably, 40 moles to 400 moles of the second aromatic dianhydride based on 100 moles of the first aromatic dianhydride.

In an example embodiment, the first aromatic dianhydride and the second aromatic dianhydride may have a molar ratio of 9:1 to 1:9, preferably 8:2 to 2:8, and more preferably is 7:3 to 3:7.

In an example embodiment, the composition for manufacturing a polyimide film may improve heat resistance and dimensional stability of the polyimide film more effectively by including two or more types of aromatic dianhydrides at a predetermined molar ratio.

The composition for manufacturing a polyimide film according to the present disclosure includes a diamine.

The diamine has characteristics capable of improving flexural properties, low repulsion properties, and dimensional stability of the polyimide film.

In an example embodiment, the diamine may include: a first diamine including p-phenylenediamine (p-PDA), m-phenylenediamine (m-PDA), or both thereof; a second diamine including 4,4′-oxydianiline (ODA), 4,4′-methylenedianiline (MDA), or both thereof; and a third diamine including 2-(4-aminophenyl)-5-amino-benzimidazole (PBI).

In an example embodiment, the third diamine may be contained in an amount of 1 mol % to 30 mol % based on the total content of the diamine.

Preferably, the third diamine may be contained in an amount of 5 mol % to 20 mol %, more preferably, 5 mol % to 15 mol %, based on the total content of the diamine.

The third diamine is one which includes an imidazole-based diamine, and may act as a key factor in improving low repulsion properties and dimensional stability of the polyimide film.

If the content of the third diamine is less than the above range, the coefficient of thermal expansion (CTE) may increase to lower dimensional stability, and if it exceeds the above content range, the coefficient of thermal expansion (CTE) is excessively reduced to increase a difference in coefficient of thermal expansion with the metal foil so that dimensional stability may deteriorate.

In an example embodiment, the diamine may include 10 moles to 50 moles of the second diamine and 1 mole to 30 moles of the third diamine based on 100 moles of the first diamine.

Preferably, the diamine may include 10 moles to 40 moles of the second diamine and 5 moles to 30 moles of the third diamine based on 100 moles of the first diamine. More preferably, the diamine may include 20 moles to 40 moles of the second diamine and 10 moles to 20 moles of the third diamine based on 100 moles of the first diamine.

In an example embodiment, the diamine may have a molar ratio of the first diamine and the second diamine of 9:1 to 1:1, preferably, 8:1 to 7:2.

In an example embodiment, the diamine may have a molar ratio of the first diamine and the third diamine of 9:1 to 1:1, preferably, 9:1 to 7:1.

In an example embodiment, the diamine may have a molar ratio of the second diamine and the third diamine of 3:1 to 1:1, preferably, 3:1 to 2:1.

In an example embodiment, the composition for manufacturing a polyimide film may have an effect capable of simultaneously improving low repulsion properties, flexural properties, and dimensional stability of the polyimide film by including three or more types of diamines at a predetermined molar ratio.

In an example embodiment, the diamine may further include one or more selected from the group consisting of 2-(4-aminophenyl)benzo[di]oxazol-5-amine (PBO), 2,5-diaminotoluene, 2,6-diaminotoluene, 1,3-bis(4,4′-aminophenoxy)benzene, 4,4′-diamino-1,5-phenoxypentane, 4,4′-diaminobiphenyl, 3,3′-dimethyl-4,4′-diaminobiphenyl, 3,3′-dimethoxy-4,4′-diaminobiphenyl, 4,4′-diaminodiphenylether, 4,4′-diaminodiphenylmethane, 2,2′-diaminodiphenylpropane, bis(3,5-diethyl-4-aminophenyl)methane, diaminodiphenylsulfone, diaminobenzophenone, diaminonaphthalene, 1,4-bis(4-aminophenoxy)benzene, 1,4-bis(4-aminophenyl)benzene, 9,10-bis(4-aminophenyl)anthracene, 1,3-bis(4-aminophenoxy)benzene, 4,4′-bis(4-aminophenoxy)diphenylsulfone, 2,2-bis[4-(4-aminophenoxy)phenyl]propane, 2,2′-trifluoromethyl-4,4′-diaminobiphenyl, 1,4-diaminocyclohexane, 1,4-cyclohexanebis(methylamine), 4,4′-diaminodicyclohexylmethane (MCA), 4,4′-methylenebis(2-methyl cyclohexylamine) (MMCA), ethylenediamine (EN), 1,3-diaminopropane (13DAP), tetramethylenediamine, 1,6-hexamethylenediamine (16DAH), and 1,12-diaminododecane (112DAD).

In an example embodiment, the diamine may be contained in an amount of 10 parts by weight to 200 parts by weight based on 100 parts by weight of the aromatic dianhydride.

Preferably, the diamine may be contained in an amount of 50 parts by weight to 150 parts by weight based on 100 parts by weight of the aromatic dianhydride, and more preferably, the diamine may be contained in an amount of 80 parts by weight to 120 parts by weight based on 100 parts by weight of the aromatic dianhydride. Even more preferably, the diamine may be contained in an amount of 100 parts by weight based on 100 parts by weight of the aromatic dianhydride, that is, the aromatic dianhydride and the diamine may be contained at a ratio of 1:1.

In an example embodiment, the content ratio of the aromatic dianhydride and the diamine may be 1:10 to 10:1, preferably, 1:5 to 5:1, and more preferably, 1:2 to 2:1.

The composition for manufacturing a polyimide film according to the present disclosure includes a curing catalyst including one or more selected from the group consisting of an imidazole-based compound, a quinolone-based compound, and a quinoline-based compound.

The curing catalyst may improve the bending resistance and dimensional stability by lowering repulsion properties of the polyimide film.

In an example embodiment, the curing catalyst may be contained in an amount of 5 parts by weight to 40 parts by weight based on 100 parts by weight of the total content of the aromatic dianhydride and diamine.

Preferably, it may be contained in an amount of 5 parts by weight to 30 parts by weight based on 100 parts by weight of the total content of the aromatic dianhydride and diamine.

Here, the total content is a value obtained by adding the content of the aromatic dianhydride and the content of the diamine.

If the content of the curing catalyst is less than the above range, tensile strength and dimensional stability may decrease, and repulsion properties may increase.

On the other hand, when the content of the curing catalyst exceeds the above range, bending resistance may be reduced.

In particular, the content of the curing catalyst is a key factor in adjusting physical properties of the polyimide film.

In an example embodiment, the imidazole-based compound may include one or more selected from the group consisting of imidazole, benzimidazole, 1-methylimidazole, 1-(trimethylsilyl)-imidazole, 1,2-dimethylimidazole, 1-(3-aminopropyl)-imidazole, 2-alkylimidazole, 2-ethylimidazole, 2-ethyl-4-methylimidazole, 2-phenylimidazole, 2-undecylimidazole, and 3-phenylimidazole.

In an example embodiment, the quinolone-based compound may include one or more selected from the group consisting of quinolone, 1,2-dihydro-2,2,4-trimethylquinolone, 2-chloro-3-(chloromethyl)quinolone, 4-(4-dimethylaminostyryl)quinolone, and 6-(aminomethyl)quinolone.

In an example embodiment, the quinoline-based compound may include one or more selected from the group consisting of quinoline, isoquinoline, and benzoquinoline.

In an example embodiment, the composition for manufacturing a polyimide film may have a solid content of 5% by weight to 20% by weight and a viscosity of 10,000 cP to 30,000 cP.

Preferably, the composition for manufacturing a polyimide film may have a solid content of 8% by weight to 15% by weight.

The solid content range is a solid content range when the composition for manufacturing a polyimide film is polyamic acid, and may be one considering the molecular weight (degree of polymerization) suitable for forming a polyimide film and workability (viscosity) during coating on one surface of the metal foil.

Further, the composition for manufacturing a polyimide film may have a viscosity of 10,000 cP to 30,000 cP, which may be one considering workability during coating.

If the viscosity of the composition for manufacturing a polyimide film is less than the above range, the solution may flow down during coating on one surface of the metal foil, and if it exceeds the above range, the solution may agglomerate during coating, which may cause a problem that the surface is not coated evenly.

The composition for manufacturing a polyimide film according to the present disclosure may further include an organic solvent.

In an example embodiment, the organic solvent may include one or more selected from the group consisting of N,N-dimethylacetamide (DMAc), N-methyl-2-pyrrolidone (NMP), N,N-dimethylforamide (DMF), dimethyl sulfoxide (DMSO), tetrahydrofuran (TFH), benzene, cresol, hexane, cyclohexane, chloroform, phenol, and halogenated phenol.

Preferably, the organic solvent may include one or more selected from the group consisting of N,N-dimethylacetamide (DMAc), N-methyl-2-pyrrolidone (NMP), N, N-dimethylforamide (DMF), and dimethyl sulfoxide (DMSO).

According to another aspect of the present disclosure, there is provided a method for preparing a composition for manufacturing a polyimide film, the method including the steps of: preparing a diamine solution by dissolving a diamine in an organic solvent; and injecting an aromatic dianhydride and a curing catalyst into the diamine solution, in which the curing catalyst includes one or more selected from the group consisting of an imidazole-based compound, a quinolone-based compound, and a quinoline-based compound.

Here, the characteristics of the organic solvent, the diamine, the aromatic dianhydride, and the curing catalyst are the same as those described above.

According to another aspect of the present disclosure, there is provided a polyimide film for a flexible metal clad laminate, which is manufactured from a composition for manufacturing a polyimide film, the composition including: an aromatic dianhydride; a diamine; and a curing catalyst, and which has a Young's modulus of 5 GPa or less and a coefficient of thermal expansion (CTE) of 15 ppm/K or less.

The polyimide film according to the present disclosure may have low repulsion and high flexural properties by controlling Young's modulus to 5 GPa or less, thereby lowering stiffness. Further, it also influences increasing MIT flexural properties.

The polyimide film according to the present disclosure may improve the dimensional stability of the flexible metal clad laminate by controlling the coefficient of thermal expansion (CTE) to 15 ppm/K or less.

The coefficient of thermal expansion (CTE) may be measured based on a film having a thickness of 20 μm in a temperature range of 100° C. to 250° C.

In an example embodiment, the polyimide film for the flexible metal clad laminate may have the number of bending of 10,000 times or more in the MIT flexural property test using the JIS C 6471 method in a state in which a coverlay is attached. In an example embodiment, the number of bending may be 13,000 times or more.

The polyimide film for a flexible metal clad laminate according to the present disclosure has excellent MIT flexural properties, that is, excellent bending resistance.

The coverlay may be composed of polyimide having a thickness of 12.5 μm and an adhesive having a thickness of 15 μm.

This is for simulating a flexible printed circuit board (FPCB) and reducing test deviation.

In an example embodiment, the polyimide film for the flexible metal clad laminate may have a dimensional change rate of 0.1% or less measured after heat treatment at a temperature of 150° C. for 30 minutes, and the dimensional change rate may be calculated by Equation 1 below.

Dimensional change rate (%)={(average distance between holes after heat treatment−average distance between holes before heat treatment)/average distance between holes before heat treatment}×100. [Equation 1]

The dimensional change rate may include both a dimensional change rate in the machine direction (MD) and a dimensional change rate in the transverse direction (TD).

In an example embodiment, the dimensional change rate in the MD may be 0.06% or less, and the dimensional change rate in the TD may be 0.05% or less.

In an example embodiment, the polyimide film for a flexible metal clad laminate may have a stiffness of 1.0 N/m to 1.7 N/m.

Preferably, the polyimide film for a flexible metal clad laminate may have a stiffness of 1.4 N/m to 1.7 N/m.

The polyimide film for a flexible metal clad laminate according to the present disclosure is characterized by having low repulsion properties and modulus by having low stiffness.

The polyimide film for a flexible metal clad laminate according to the present disclosure secures excellent dimensional stability and reduces repulsion properties so that it is deformed according to various demands to enable adhesive properties to be maintained even when the contact area with other materials is reduced.

For example, even if the area of the display terminal portion is reduced for various reasons, and thus the FPCB adhesion area of the display panel edge portion is reduced, it may be possible to prevent the adhesion portion from falling off by lowering repulsion properties of the polyimide film layer.

According to another aspect of the present disclosure, there is provided a flexible metal clad laminate including: a metal foil; and the polyimide film laminated on one or both surfaces of the metal foil.

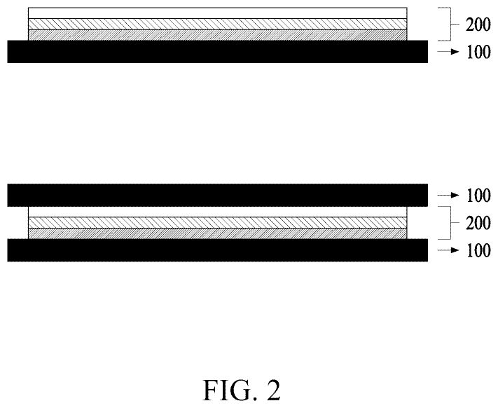

FIG. 2 is a drawing showing a cross-section of a flexible metal clad laminate according to an example embodiment of the present disclosure.

Referring to FIG. 2, it can be confirmed that the polyimide film layer is formed by coating one or both surfaces of the metal foil with the composition for manufacturing polyimide once or plural times.

According to an example embodiment, the polyimide film may be laminated by coating the composition for manufacturing a polyimide film according to the present disclosure on one or both surfaces of the metal foil.

The coating may be performed by slot die coating, comma coating, reverse comma coating, cast coating, or dip coating.

The coating may be performed multiple times, and a drying process after coating may be performed together. The drying may be performed in a temperature range of 100° ° C. to 200° C. for 1 minute to 20 minutes, and it may be maintained at the highest temperature for 1 minute to 8 minutes, and then cooling may be performed.

According to an example embodiment, the polyimide film may be cured after coating.

The curing may be carried out under a nitrogen atmosphere, performed in a temperature range of 300° ° C. to 400° C. for 5 minutes to 60 minutes, and maintained at the highest temperature for 1 minute to 15 minutes, and then cooling may be performed. At this time, the highest temperature may be reached by raising the temperature for 5 minutes to 30 minutes.

In an example embodiment, the metal foil may include one or more selected from the group consisting of a rolled copper foil (RA, roo-annealed), an electrodeposited copper foil (ED, electrodeposition), an aluminum foil, and a nickel foil.

For example, the flexible metal clad laminate may be a flexible copper clad laminate (FCCL).

In an example embodiment, the polyimide film may have a thickness of 5 μm to 100 μm.

Hereinafter, the present disclosure will be described in more detail by Examples and Comparative Examples.

However, the following Examples are only for illustrating the present disclosure, and the content of the present disclosure is not limited to the following Examples.

### <Examples> Production of Composition for Manufacturing Polyimide Film and Flexible Metal Clad Laminate

### 1) Preparation of a Composition for Manufacturing a Polyimide Film

After dissolving a diamine in an organic solvent, an aromatic dianhydride and a curing catalyst were mixed to prepare a composition for manufacturing a polyimide film.

### 2) Manufacturing of a Flexible Metal Clad Laminate

The prepared composition for manufacturing a polyimide film was applied to one surface of a metal foil, and dried in a temperature range of 100° C. to 200° ° C. for 10 minutes to 20 minutes.

Thereafter, the dried laminate was cured to a temperature range of 300° C. to 400° C. in an infrared heat supply-type continuous curing machine.

At this time, nitrogen was supplied into the curing machine, the temperature was raised from room temperature to 300° ° C. to 400° C. within 30 minutes, it was maintained at the highest temperature within 10 minutes, and then cooling was performed.

The polyimide film was formed to a thickness of 7.5 μm to 50 μm.

### <Comparative Examples> Production of Composition for Manufacturing Polyimide Film and Flexible Metal Clad Laminate

A composition for manufacturing a polyimide film and a flexible metal clad laminate were produced in the same manner as in Examples except that only one type of dianhydride and two types of diamines were used without using a curing catalyst when preparing a composition for manufacturing a polyimide film.

Specific compositions of the components of Examples and Comparative Examples are shown in Table 1.

TABLE 1

| | Anhydride content | | Amine content | | | |
|---|---|---|---|---|---|---|
| | (mol %) | | (mol %) | | | Curing catalyst |
| | PMDA | BPDA | PDA | MDA/ODA | PBI | (PHR % by weight) |
| Example 1 | 40 | 60 | 70 | 20 | 10 | 30 |
| Example 2 | 40 | 60 | 70 | 20 | 10 | 20 |
| Example 3 | 40 | 60 | 70 | 20 | 10 | 15 |
| Example 4 | 40 | 60 | 70 | 20 | 10 | 8 |
| Example 5 | 20 | 80 | 70 | 20 | 10 | 15 |
| Example 6 | 70 | 30 | 70 | 20 | 10 | 15 |
| Comparative | 100 | 0 | 90 | 10 | 0 | 0 |
| Example 1 | | | | | | |
| Comparative | 0 | 100 | 90 | 10 | 0 | 0 |
| Example 2 | | | | | | |
| Comparative | 40 | 60 | 90 | 10 | 0 | 0 |
| Example 3 | | | | | | |
| Comparative | 40 | 60 | 90 | 10 | 0 | 50 |
| Example 4 | | | | | | |

* PHR: per hundred resin or parts per hundreds of rubber

### <Experimental Example> Measurement of Physical Properties of Polyimide Films

In the flexible metal clad laminates manufactured in Examples 1 to 6 and Comparative Examples 1 and 2, the metal was etched with a ferric chloride solution and washed with distilled water to separate polyimide films. The physical properties of the separated polyimide films were measured by the following methods.

### 1) Tensile Strength

UTM (INSTRON-3345) was used, and the polyimide films were cut into 10 mm in width and 100 mm in length (measurement effective range of 50 mm) and measured at a rate of 50.8 mm/min.

### 2) Repulsion Properties

A Loop Stiffness Tester (TOYOSEKI-DA) was used, and specimens obtained by cutting polyimide films with a thickness of 12.5 μm to a width of 15 mm and a length of 100 mm or more were fixed to the measuring table. At this time, the lengths of the specimens actually measured were 50 mm, and when they were formed in a loop shape, the widths thereof were 20 mm. The measurement was performed at the condition of Force Detector 13 mm.

### 3) Coefficient of Thermal Expansion (CTE)

TMA (HITACHI-7100) was used, 20 μm thick polyimide films were cut to about 4 mm in width and 50 mm in length, a tension of force 30 mN was applied, and coefficient of thermal expansion values were measured in the range of 100° C. to 250° C.

### 4) MIT Flexural Properties

The measurement was performed through the JIS 6471 method using MIT-DA (TOYOSEKI). Coverlay (PI-12.5 μm, Adhesive-15 μm) was attached to perform the measurement through MIT measuring equipment, and repeated bending was performed at 90° or 135° to measure the number of bending until the pattern was disconnected.

The coverlay was attached during measurement to simulate a flexible printed circuit board (FPCB) and reduce test deviation.

### 5) Dimensional Stability

Flexible copper clad laminates (FCCLs) of 290×270 mm size were fully etched, naturally dried, and then stored at 23° C./50% RH for 2 hours to measure the positions between holes. The holes are drilled at positions where vertexes of 250×230 mm from the center of the specimens are positioned. After applying heat to them at 150° C. for 30 minutes, they were stored at 23° C./50% RH conditions for 2 hours to measure the positions between the holes.

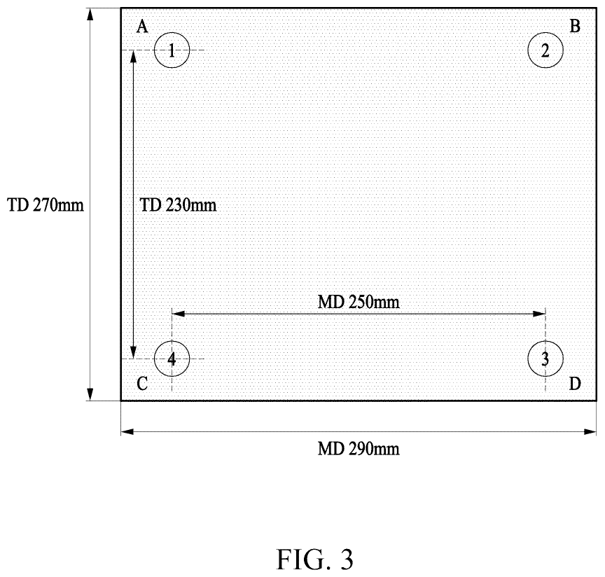

FIG. 3 is for explaining the specific calculation method of the dimensional change rate, and shows the position of each hole in the specimen.

The dimensional change rate (Heating DS) was calculated by the following Formula.
Dimensional change rate in MID (%)=(L_{M2}−L_{M})/L_{M}×100
Dimensional change rate in TD (%)=(L_{T2}−L_{T})/L_{T}×100
L_{M}=(Distance between holes A and B+Distance between holes C and D)/2
L_{T}=(Distance between holes A and C+Distance between holes B and D)/2
L_{M}: Average distance between holes in the MD of the disk
L_{M1}: Average distance between holes in the MD after etching
L_{M2}: Average distance between holes in the MD after heating
L_{T}: Average distance between holes in the TD of the disk
L_{T1}: Average distance between holes in the TD after etching
L_{T2}: Average distance between holes in the TD after heating

Each of the evaluated physical property values is shown in Table 2.

TABLE 2

| | | | | MIT | |
|---|---|---|---|---|---|
| | | | | flexural | |
| | | | | properties | |
| | Young's | | Repulsion | C/L | Heating DS |
| | modulus | CTE | properties | attachment | MD/TD |
| | (GPa) | (ppm/k) | (N/m) | (times) | (%) |
| Example 1 | 4.9 | 14.9 | 1.67 | 13,000 | 0.05/0.05 |
| Example 2 | 4.7 | 14.8 | 1.60 | 15,000 | 0.06/0.04 |
| Example 3 | 4.6 | 13.1 | 1.47 | 17,000 | 0.03/0.00 |
| Example 4 | 4.7 | 12.8 | 1.61 | 15,900 | 0.02/0.01 |
| Example 5 | 4.7 | 13.9 | 1.60 | 16,100 | 0.04/0.05 |
| Example 6 | 4.7 | 12.3 | 1.59 | 16,000 | 0.03/0.02 |
| Comparative | 6.0 | 9.5 | 1.83 | 10,000 | 0.00/−0.01 |
| Example 1 | | | | | |
| Comparative | 4.2 | 25.7 | 1.32 | 18,200 | 0.13/0.15 |
| Example 2 | | | | | |
| Comparative | 5.8 | 16.5 | 2.14 | 8,200 | 0.12/0.10 |
| Example 3 | | | | | |
| Comparative | 6.0 | 17.9 | 2.19 | 7,500 | 0.15/0.15 |
| Example 4 | | | | | |

Referring to Table 2, it can be confirmed that the polyimide films of Examples had excellent MIT flexural properties, dimensional stabilities, and heat resistances, and exhibit low repulsion properties compared to those of Comparative Examples. Specifically, the polyimide films of Examples showed excellent bending resistances by showing the number of bending of 13,000 times or more in the evaluation of MIT flexural properties after attaching the coverlay.

Further, the modulus (Young's modulus) values were found to be about 4.5 GPa to 5 GPa, and the coefficient of linear thermal expansion (CTE) values measured in the range of 100° ° C. to 250° ° C. were found to be about 12 ppm/k to 15 ppm/k.

According to the repulsion property test result, it can be confirmed that the polyimide films of the Examples showed stiffness values of 1.7 N/m or less, thereby showing values which were lower than those of the polyimide films of the Comparative Examples.

That is, it can be confirmed that the polyimide films of the Examples showed low stiffness values so that repulsion properties were low, and it can be seen through this that the polyimide films of the Examples had low modulus properties.

Although the above-mentioned example embodiments have been described by limited drawings, those skilled in the art may apply various technical modifications and alterations based on the above-mentioned description. For example, appropriate results can be achieved although described techniques are carried out in a different order from a described method, and/or described elements of a system, structure, apparatus, circuit, etc. are combined or mixed in a different form from the described method, or replaced or substituted with other elements or equivalents.

Therefore, other example embodiments, other Examples, and equivalents to patent claims belong to the scope of the patent claims to be described later.

1. A composition for manufacturing a polyimide film, the composition comprising:
an aromatic dianhydride; a diamine; and a curing catalyst,
wherein the curing catalyst includes one or more selected from the group consisting of an imidazole-based compound, a quinolone-based compound, and a quinoline-based compound.

2. The composition of claim 1, wherein the aromatic dianhydride includes one or more selected from the group consisting of pyromellitic dianhydride (PMDA), biphenyltetracarboxylic dianhydride (BPDA), bisphenol-A dianhydride (BPADA), and 4,4′-(hexafluoropropylidene)diphthalic anhydride (6FDA).

3. The composition of claim 1, wherein the diamine includes:
a first diamine including p-phenylenediamine (p-PDA), m-phenylenediamine (m-PDA), or both thereof;
a second diamine including 4,4′-oxydianiline (ODA), 4,4′-methylenedianiline (MDA), or both thereof; and
a third diamine including 2-(4-aminophenyl)-5-amino-benzimidazole (PBI).

4. The composition of claim 3, wherein the third diamine is contained in an amount of 1 mol % to 30 mol % based on the total content of the diamine.

5. The composition of claim 1, wherein the diamine is contained in an amount of 10 parts by weight to 200 parts by weight based on 100 parts by weight of the aromatic dianhydride.

6. The composition of claim 1, wherein the curing catalyst is contained in an amount of 5 parts by weight to 40 parts by weight based on 100 parts by weight of the total content of the aromatic dianhydride and the diamine.

7. The composition of claim 1, wherein the imidazole-based compound includes one or more selected from the group consisting of imidazole, benzimidazole, 1-methylimidazole, 1-(trimethylsilyl)-imidazole, 1,2-dimethylimidazole, 1-(3-aminopropyl)-imidazole, 2-alkylimidazole, 2-ethylimidazole, 2-ethyl-4-methylimidazole, 2-phenylimidazole, 2-undecylimidazole, and 3-phenylimidazole.

8. The composition of claim 1, wherein the quinolone-based compound includes one or more selected from the group consisting of quinolone, 1,2-dihydro-2,2,4-trimethylquinolone, 2-chloro-3-(chloromethyl)quinolone, 4-(4-dimethylaminostyryl)quinolone, and 6-(aminomethyl) quinolone.

9. The composition of claim 1, wherein the quinoline-based compound includes one or more selected from the group consisting of quinoline, isoquinoline, and benzoquinoline.

10. The composition of claim 1, wherein the composition for manufacturing a polyimide film has a solid content of 5% by weight to 20% by weight and a viscosity of 10,000 cP to 30,000 cP.

11. A method for preparing a composition for manufacturing a polyimide film, the method comprising steps of:
preparing a diamine solution by dissolving a diamine in an organic solvent; and
injecting an aromatic dianhydride and a curing catalyst into the diamine solution,
wherein the curing catalyst includes one or more selected from the group consisting of an imidazole-based compound, a quinolone-based compound, and a quinoline-based compound.

12. A polyimide film for a flexible metal clad laminate, which is manufactured from a composition for manufacturing a polyimide film, the composition comprising: an aromatic dianhydride; a diamine; and a curing catalyst, and which has a Young's modulus of 5 GPa or less and a coefficient of thermal expansion (CTE) of 15 ppm/K or less.

13. The polyimide film of claim 12, wherein the polyimide film for the flexible metal clad laminate has the number of bending of 10,000 times or more in an MIT flexural property test using a JIS C 6471 method in a state in which a coverlay is attached.

14. The polyimide film of claim 12, wherein the polyimide film for the flexible metal clad laminate has a dimensional change rate of 0.1% or less measured after heat treatment at a temperature of 150° C. for 30 minutes, and the dimensional change rate is calculated by the following Equation 1:
Dimensional change rate (%)={(average distance between holes after heat treatment−average distance between holes before heat treatment)/average distance between holes before heat treatment}×100. [Equation 1]

15. The polyimide film of claim 12, wherein the polyimide film for the flexible metal clad laminate has a stiffness of 1.0 N/m to 1.7 N/m.

16. A flexible metal clad laminate comprising:
a metal foil; and
a polyimide film laminated on one or both surfaces of the metal foil,
wherein the polyimide film is the polyimide film of claim 12.

17. The flexible metal clad laminate of claim 16, wherein the metal foil includes one or more selected from the group consisting of a rolled copper foil (RA, roo-annealed), an electrodeposited copper foil (ED, electrodeposition), an aluminum foil, and a nickel foil.
